(19) United States
(12) Patent Application Publication
(10) Pub. No.: US 2010/0156268 A1
(43) Pub. Date: Jun. 24, 2010

(54) Phosphor compositions for white discharge cell and plasma display panel using the same

(75) Inventors: Young-Gil Yoo, Suwon-si (KR); Young-Kwan Kim, Suwon-si (KR); Jeong-Hyeon Ha, Suwon-si (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., Ltd., Suwon-si (KR)

(21) Appl. No.: 12/654,580

(22) Filed: Dec. 23, 2009

(30) Foreign Application Priority Data
Dec. 23, 2008 (KR) 10-2008-0132203

(51) Int. Cl. H01J 63/04

(52) U.S. Cl. 313/487; 313/485

(57) ABSTRACT

Provided are a phosphor composition formed in a white discharge cell of a plasma display panel (PDP) and a PDP using the same. The PDP includes a first substrate and a second substrate facing the first substrate, a barrier rib disposed between the first substrate and second substrate to define a plurality of discharge cells, first discharge electrodes and second discharge electrodes disposed between the first substrate and the second substrate, and a phosphor composition. The discharge cells includes red discharge cells, green discharge cells, blue discharge cells, and white discharge cells, and the phosphor composition is formed in the white discharge cells. One of the red discharge cells, one of the green discharge cells, one of the blue discharge cells, and one of the white discharge cells form a pixel. The composition ratio of each of the phosphors to another is different from each other. Since the white phosphor layer includes red, green, and blue phosphors each of which having a different composition ratio within a predetermined range, light room contrast may be improved by controlling brightness in the white discharge cell, and difference of efficiencies in red, green, and blue discharge cells may be compensated.

### CLAIM OF PRIORITY

This application makes reference to, incorporates the same herein, and claims all benefits accruing under 35 U.S.C. §119 from an application earlier filed in the Korean Intellectual Property Office on 23 Dec. 2008 and there duly assigned Serial No. 10-2008-0132203.

### BACKGROUND OF THE INVENTION

1. Field of the Invention

An aspect of the present invention relates to a plasma display panel, and more particularly, to a phosphor composition for improving brightness, and a plasma display panel using the same.

2. Description of the Related Art

Generally, a plasma display panel (PDP) refers to a flat panel display device that displays desired numerals, characters, and/or graphics via a discharging gas sealed between a plurality of substrates on each of which a plurality of discharge electrodes are patterned. During operation of the PDP, predetermined discharge voltages are applied to the discharge electrodes from an external power source, and phosphors in discharge cells formed between the plurality of substrates is excited by ultraviolet rays generated by the discharging gas in response to the applied discharge voltages.

In case of a conventional three electrode surface discharging type PDP, the PDP includes a first substrate and a second substrate. In the first substrate, a pair of discharge sustain electrode including an X electrode and a Y electrode is formed. A first dielectric layer is formed to cover the pair of the discharge sustain electrode, and a protective layer is formed on the surface of the first substrate. An address electrode is formed on the top surface of the second substrate in a direction crossing a direction in which the pair of the discharge sustain electrode extends. A second dielectric layer is formed to cover the address electrode. A barrier rib is disposed between the first and second substrates to define discharge cells, and each of the discharge cells includes red, green, and blue phosphor layers.

In such a conventional PDP, when electric signals are applied to an address electrode and a Y electrode, a discharge cell for light emission is selected. When electric signals are alternately applied to an X electrode and a Y electrode, visible light is emitted from the phosphor in the phosphor layer applied inside a selected discharge cell. Thus, still images and/or motion pictures are displayed.

### SUMMARY OF THE INVENTION

The present invention provides a phosphor composition of a white discharge cell, which includes a red phosphor, a green phosphor, and a blue phosphor, with discharging efficiency improved by adjusting a composition ratio of the red, green, and blue phosphors, and provides a plasma display panel (PDP) using the phosphor composition of the white discharge cell.

According to an aspect of the present invention, there is provided a phosphor composition formed in a white discharge cell of a plasma display panel. The phosphor composition includes a red phosphor, a green phosphor, and a blue phosphor, and a composition ratio of each of the red, green and blue phosphors to another is different from each other.

Furthermore, the red phosphor includes from 25 weight % to 28 weight %, the green phosphor includes from 44 weight % to 48 weight %, the blue phosphor includes from 25 weight % to 29 weight %, and total composition of the red, green and blue phosphors is 100 weight %. The red phosphor may include (Y,Gd)BO₃:Eu⁺³, the green phosphor may include (Y,Gd)Al₃(BO₃)₄:Tb, and the blue phosphor may include BaMgAl₁₀O₁₇:Eu²⁺.

According to another aspect of the present invention, there is provided a PDP including a first substrate and a second substrate facing the first substrate, a barrier rib disposed between the first substrate and second substrate to define a plurality of discharge cells including red discharge cells, green discharge cells, blue discharge cells, and white discharge cells, a plurality of first discharge electrodes disposed between the first substrate and the second substrate, a plurality of second discharge electrodes disposed between the first substrate and the second substrate, and a phosphor composition formed in the white discharge cells. The first discharge electrodes extend in a first direction, and the second discharge electrodes extend in a second direction crossing the first direction. The phosphor composition includes a red phosphor, a green phosphor, and a blue phosphor. A composition ratio of each of the red, green and blue phosphors to another is different from each other.

Furthermore, the red phosphor includes from 25 weight % to 28 weight %, the green phosphor includes from 44 weight % to 48 weight %, the blue phosphor includes from 25 weight % to 29 weight %, and total composition of combined phosphors is 100 weight %. The red phosphor may include (Y,Gd)BO₃:Eu⁺³, the green phosphor may include (Y,Gd)Al₃(BO₃)₄:Tb, and the blue phosphor may include BaMgAl₁₀O₁₇:Eu²⁺.

The red phosphor may be formed in the red discharge cells, the green phosphor is formed in the green discharge cells, and the blue phosphor is formed in the blue discharge cells. One of the red discharge cells, one of the green discharge cells, one of the blue discharge cells, and one of the white discharge cells may form a pixel.

Each of the first discharge electrodes includes a X electrode and a Y electrode extending substantially parallel to the X electrode.

The PDP may further include a first dielectric layer formed on an inward surface of the first substrate, the first electrodes being disposed between the first substrate and the first dielectric layer. The first electrodes may be disposed between the first substrate and the barrier rib.

The PDP may further include a second dielectric layer formed on an inward surface of the second substrate, the second electrodes being disposed between the second substrate and the second dielectric layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded view partially illustrating a plasma display panel (PDP) according to an embodiment of the present invention;

FIG. 2 is a sectional view obtained along a line II-II of FIG. 1 when the PDP of FIG. 1 is assembled; and

FIG. 3 is a diagram illustrating an arrangement of discharge cells of FIG. 1.

### DETAILED DESCRIPTION OF THE INVENTION

A plasma display panel (PDP) according to an embodiment of the present invention will now be described more fully with reference to the accompanying drawings, in which exemplary embodiments of the invention are shown. As those skilled in the art would realize, the described embodiments may be modified in various different ways, all without departing from the spirit or scope of the present invention.

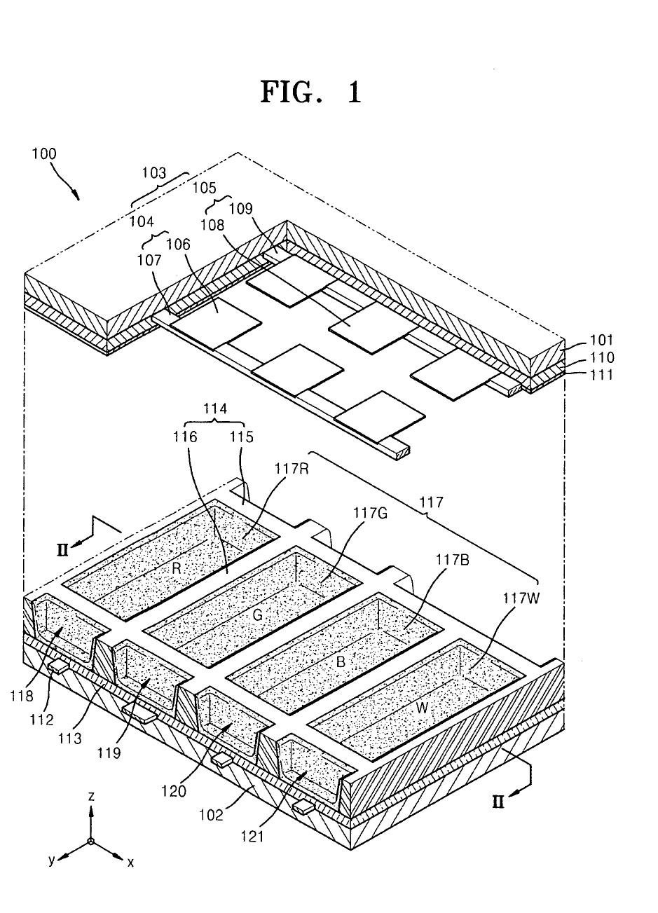

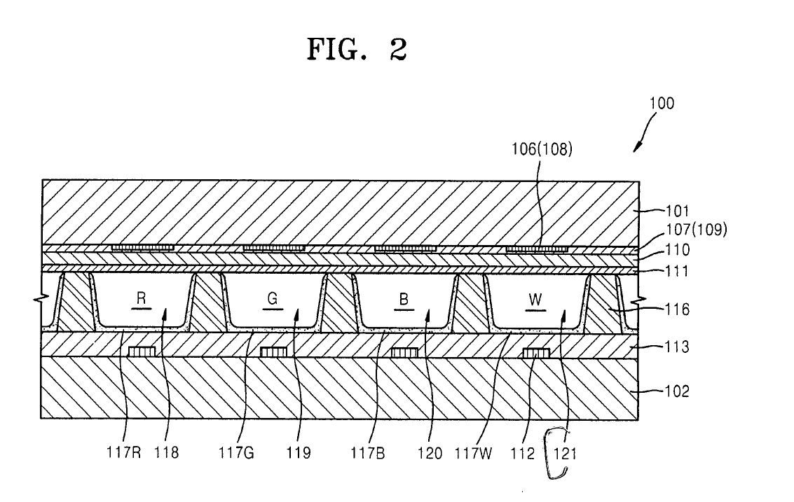

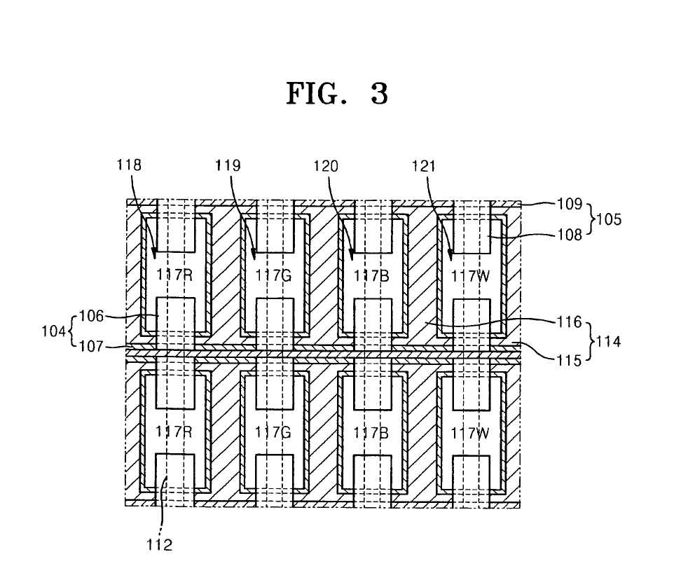

FIG. 1 is an exploded view partially illustrating a PDP 100 according to an embodiment of the present invention. FIG. 2 is a sectional view obtained along a line II-II of FIG. 1 when the PDP 100 is assembled. FIG. 3 is a diagram illustrating an arrangement of discharge cells of FIG. 1.

Referring to FIGS. 1 through 3, the PDP 100 includes a first substrate 101 and a second substrate 102, wherein the second substrate 102 is disposed in parallel to the first substrate 101. Frit glass (not shown) is applied along edges of inward surfaces of the first and second substrates 101 and 102. The inward surfaces of the first and second substrates 101 and 102 face each other, and a discharge space between the first and second substrates 101 and 102 is sealed from outside.

The first substrate 101 is a transparent substrate formed of a material that transmits visible light, e.g., soda lime glass. Alternatively, the first substrate 101 may be a semi-transparent substrate, a colored substrate, or a reflective substrate according to purposes.

X electrodes 104 and Y electrodes 105, which constitutes a pair of discharge electrodes 103 (or a first discharge electrode), are disposed on the inward surface of the first substrate 101. The X electrode 104 and the Y electrode 105, each of which extends along X direction (or a first direction), are alternately disposed in the Y direction (or a second direction) of the PDP 100. Each of discharge cells includes the pair of the X electrode 104 and the Y electrode 105.

The X electrode 104 includes an X transparent electrode 106, which is separately disposed in each of the discharge cells, and an X bus electrode 107, which is disposed in the X direction of the PDP 100 for electrically connecting the X transparent electrodes 106 in adjacent discharge cells. In the present embodiment, a shape of the cross-section of the X transparent electrode 106 is a rectangle and a shape of the X bus electrode 107 is a stripe. However, the present invention is not limited thereto.

The Y electrode 105 includes a Y transparent electrode 108, which is separately disposed in each of the discharge cells, and a Y bus electrode 109, which is disposed in the X direction of the PDP 100 for electrically connecting the Y transparent electrodes 108 in adjacent discharge cells. Shapes of the Y transparent electrode 108 and the Y bus electrode 109 are the same as those of the X transparent electrode 106 and the X bus electrode 107, respectively.

The X transparent electrode 106 and the Y transparent electrode 108 are disposed around the center of each of the discharge cells, but do not contact each other. The X transparent electrode 106 and the Y transparent electrode 108 are apart from each other, and disposed maintaining a predetermined gap that constitutes a discharge gap.

The X transparent electrode 106 and the Y transparent electrode 108 may be formed of a transparent conductive film, such as an indium tin oxide film, for improving the aperture ratio of the first substrate 101. The X bus electrode 107 and the Y bus electrode 109 may be formed of metals with excellent conductivity, such as Ag paste or a multi layer of Cr—Cu—Cr, for improving electrical conductivity of the X transparent electrode 106 and the Y transparent electrode 108.

A space between a pair of discharge electrodes 103 and another pair of discharge electrodes 103 adjacent thereto constitutes a non-discharge area. In the non-discharge area, a black stripe layer may further be formed for improving contrast.

The X electrode 104 and the Y electrode 105 are covered by a first dielectric layer 110. The first dielectric layer 110 is formed of a highly dielectric material, such as ZnO—B₂O₃—Bi₂O₃. The first dielectric layer 110 may either be selectively formed only in the case where the pair of discharge electrodes 103 is formed or may include the pair of discharge electrodes 103 and be formed on the entire inward surface of the first substrate 101.

A protective layer 111 is formed on the first dielectric layer 110 to prevent damage to the first dielectric layer 110 and to increase emission amount of secondary electrons.

The second substrate 102 is formed of the same substrate material as the first substrate 101. An address electrode 112 (or a second discharge electrode) is disposed on the inward surface of the second substrate 102. The address electrode 112 extends in a direction crossing a direction in which the pair of discharge electrodes 103 extends. The address electrode 112 has a stripe shape. The address electrode 112 is covered by a second dielectric layer 113. The second dielectric layer 113 is formed of a highly dielectric material, such as PbO—B₂O₃—SiO₂.

A barrier rib 114 is disposed between the first and second substrates 101 and 102. The barrier rib 114 includes a first barrier rib 115 extending in the X direction of the PDP 100 and a second barrier rib 116 extending in the Y direction of the PDP 100. The first and second barrier ribs 115 and 116 are combined to each other to form a lattice-type barrier rib.

Alternatively, the barrier rib 114 may be one of various types of barrier ribs, such as a meander type, a delta type, a waffle type, a honeycomb type, etc.

Meanwhile, a discharge gas, such as Ne—Xe or He—Xe, is injected into discharge cells formed by the first substrate 101, the second substrate 102, and the barrier rib 114.

Furthermore, phosphor layers 117, which emit visible light when excited by ultraviolet rays emitted from the discharge gas, are formed within the plurality of discharge cells. The phosphor layers 117 may be formed on any region of the discharge cells. In the present embodiment, the phosphor layers 117 having the same predetermined thickness are formed on the inward surface of the second substrate 102 and the inner walls of the barrier rib 114.

The plurality of discharge cells includes a red discharge cell 118 in which a red phosphor layer 117R is formed, a green discharge cell 119 in which a green phosphor layer 117G is formed, a blue discharge cell 120 in which a blue phosphor layer 117B is formed, and a white discharge cell 121 in which a white phosphor layer 117W including red phosphor, green phosphor, and blue phosphor is formed. A composition ratio of each of the phosphors to another in the white discharge cell 121 is different from each other.

The barrier rib 114 is disposed between the first substrate 101 and the second substrate 102 and defines the plurality of discharge cells. The barrier rib 114 is formed of a dielectric material capable of inducing electric charges during discharging, and may be formed of a mixture of glass powders, organic vehicles, and various fillers.

The plurality of discharge cells includes the red discharge cell 118, the green discharge cell 119, the blue discharge cell 120, and the white discharge cell 121. Although shapes of cross-sections of the red discharge cell 118, the green discharge cell 119, the blue discharge cell 120, and the white discharge cell 121 are rectangles, the present invention is not limited thereto, and the discharge cells may have various shapes such as triangles, polygons such as pentagons, circles, ellipses, etc.

The red discharge cell 118, the green discharge cell 119, the blue discharge cell 120, and the white discharge cell 121 are alternately disposed in the X direction of the PDP 100, and are repeatedly disposed in the Y direction of the PDP 100. In other words, The red discharge cell 118, the green discharge cell 119, the blue discharge cell 120, and the white discharge cell 121 are sequentially disposed in X direction forming a set. The set of the red discharge cell 118, the green discharge cell 119, the blue discharge cell 120, and the white discharge cell 121 is repeatedly arranged along X and Y directions. At this point, four closely and repeatedly formed discharge cells, which include the red discharge cell 118, the green discharge cell 119, the blue discharge cell 120, and the white discharge cell 121, constitute one pixel that is a base unit to display an image.

The red phosphor layer 117R formed in the red discharge cell 118 may be formed of either (Y,Gd)BO₃:Eu⁺³ or Y(P,V)O₄:Eu. The green phosphor layer 117G formed in the green discharge cell 119 may be formed of either (Y,Gd)BO₃:Tb or Zn₂SiO₄:Mn²⁺. The blue phosphor layer 117B formed in the blue discharge cell 120 may be formed of either BaMgAl₁₀O₁₇:Eu²⁺ or CaMgSi₂O₆:Eu²⁺. The red, green, and blue phosphor layers 117R, 117G, and 117B have all white color in appearance, and emit red light, green light, and blue light when they are excited by ultraviolet rays.

The white phosphor layer 117W formed in the white discharge cell 121 is formed of a compound of red, green, and blue phosphors. The white phosphor layer 117 includes (Y,Gd)BO₃:Eu⁺³ as the red phosphor, (Y,Gd)Al₃(BO₃)₄:Tb as the green phosphor, and BaMgAl₁₀O₁₇:Eu²⁺ as the blue phosphor. The white phosphor layer 117W has white color in appearance, and emits white light when excited by ultraviolet rays.

A composition ratio of each of the phosphors to another in the white discharge cell 121 is different from each other.

In other words, the red phosphor of the white phosphor layer 117W includes from 25 weight % to 28 weight % of (Y,Gd)BO₃:Eu⁺³, the green phosphor of the white phosphor layer 117W includes from 44 weight % to 48 weight % of (Y,Gd)Al₃(BO₃)₄:Tb, and the blue phosphor of the white phosphor layer 117W includes from 25 weight % to 29 weight % of BaMgAl₁₀O₁₇:Eu²⁺, wherein the total composition of the red, green, and blue phosphors in the white phosphor layer 117W is 100 weight %.

A process of manufacturing phosphors layers of the PDP 100 will be described as follows. A raw material for a red phosphor layer including either 100 weight % of (Y,Gd)BO₃:Eu⁺³ or 100 weight % of Y(P,V)O₄:Eu is coated in the red discharge cell 118. Thus, the red phosphor layer 117R may be formed in the red discharge cell 118. A raw material for a green phosphor layer including either 100 weight % of (Y,Gd)BO₃:Tb or 100 weight % of Zn₂SiO₄:Mn²⁺ is coated in the green discharge cell 119. Thus, the green phosphor layer 117G may be formed in the green discharge cell 119. A raw material for a blue phosphor layer including either 100 weight % of BaMgAl₁₀O₁₇:Eu²⁺ or 100 weight % of CaMgSi₂O₆:Eu²⁺ is coated in the blue discharge cell 120. Thus, the blue phosphor layer 117B may be formed in the blue discharge cell 120. A mixture of the raw material for the red phosphor layer including from 25 weight % to 28 weight % of (Y,Gd)BO₃:Eu⁺³, the raw material for the green phosphor layer including from 44 weight % to 48 weight % of (Y,Gd)Al₃(BO₃)₄:Tb, and the raw material for the blue phosphor layer including from 25 weight % to 29 weight % of BaMgAl₁₀O₁₇:Eu² is coated in the white discharge cell 121. Thus, the white phosphor layer 117W having the total composition of 100 weight % may be formed in the white discharge cell 121.

Operations of the PDP 100 will be described below.

First, when a predetermined pulse voltage is applied between the address electrode 112 and the Y electrode 105 from an external power source, discharge cells among the discharge cells 118 through 121 are selected for light emission. Wall charges are collected on the inner walls of the selected discharge cells among the discharge cells 118 through 121.

Next, when a positive voltage is applied to the X electrode 104 and a voltage relatively higher than the positive voltage is applied to the Y electrode 105, the wall charges are moved due to difference between the voltages applied to the X and Y electrodes 104 and 105.

A discharge occurs when the moving wall charges collide against atoms of the discharge gas in the selected discharge cells among the discharge cells 118 through 121, and plasma is generated from the discharge. Such discharge is extended from a discharge gap between the X transparent electrode 106 and the Y transparent electrode 108 toward the X bus electrode 107 and the Y bus electrode 109.

After the discharge occurs as described above, if the difference of voltages between the X and Y electrodes 104 and 105 becomes lower than a discharging voltage, the discharge no longer occurs, and space electric charges and wall charges are formed in the discharge cells.

At this point, if polarities of voltages applied to the X and Y electrodes 104 and 105 are reversed, a discharge occurs again due to the wall charges. Accordingly, a discharge repeatedly occurs by repeatedly reversing polarities of the X and Y electrodes 104 and 105. The repetition stabilizes the discharge.

Meanwhile, ultraviolet rays generated by the discharge excite phosphors of the red, green, blue, and white phosphor layers 117R through 117W formed within the selected discharge cells among the discharge cells 118 through 121. Thus, visible light is generated. Generated visible light is emitted into the selected discharge cells among the discharge cells 118 through 121 to display still images or motion pictures.

At this point, since the white phosphor layer 117W formed within the white discharge cell 121 includes red, green, and blue phosphors each of which having a predetermined composition ratio, brightness may be controlled in the white discharge cell 121. As compared to the contemporary technology in which only red, green, and blue discharge cells are formed, brightness may be improved by 30% or more in the plasma display panel constructed according to the present invention in which red, green, blue, and white discharge cells are formed.

As described above, in a phosphor composition of a white discharge cell and a PDP including the same according to the present invention, each pixel includes red, green, blue, and white discharge cells. In the red, green, blue, and white discharge cells, red, green, blue, and white phosphor layers are formed, respectively. Since the white phosphor layer includes red, green, and blue phosphors each of which having a different composition ratio within a predetermined range, light room contrast may be improved by controlling brightness in the white discharge cell, and difference of efficiencies in red, green, and blue discharge cells may be compensated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A phosphor composition formed in a white discharge cell of a plasma display panel, the phosphor composition comprising:
a red phosphor;
a green phosphor; and
a blue phosphor, a composition ratio of each of the red, green and blue phosphors to another being different from each other.

2. The phosphor composition of claim 1, wherein the red phosphor has from 25 weight % to 28 weight %, the green phosphor has from 44 weight % to 48 weight %, the blue phosphor has from 25 weight % to 29 weight % of, and total composition of the red, green and blue phosphors is 100 weight %.

3. The phosphor composition of claim 2, wherein the red phosphor includes (Y,Gd)BO₃:Eu⁺³, the green phosphor includes (Y,Gd)Al₃(BO₃)₄:Tb, and the blue phosphor includes BaMgAl₁₀O₁₇:Eu²⁺.

4. The phosphor composition of claim 3, wherein the red discharge cell, the green discharge cell, the blue discharge cell, and the white discharge cell form a pixel.

5. A plasma display panel (PDP) comprising:
a first substrate;
a second substrate facing the first substrate;
a barrier rib disposed between the first substrate and second substrate to define a plurality of discharge cells including red discharge cells, green discharge cells, blue discharge cells, and white discharge cells;
a plurality of first discharge electrodes disposed between the first substrate and the second substrate, the first discharge electrodes extending in a first direction;
a plurality of second discharge electrodes disposed between the first substrate and the second substrate, the second discharge electrodes extending in a second direction crossing the first direction; and
a phosphor composition formed in the white discharge cells, the phosphor composition comprising:
a red phosphor;
a green phosphor; and
a blue phosphor, a composition ratio of each of the red, green and blue phosphors to another being different from each other.

6. The PDP of claim 5, wherein the red phosphor has from 25 weight % to 28 weight %, the green phosphor has from 44 weight % to 48 weight %, the blue phosphor has from 25 weight % to 29 weight %, and total composition of the red, green and blue phosphors is 100 weight %.

7. The PDP of claim 6, wherein the red phosphor includes (Y,Gd)BO₃:Eu⁺³, the green phosphor includes (Y,Gd)Al₃(BO₃)₄:Tb, and the blue phosphor includes BaMgAl₁₀O₁₇:Eu²⁺.

8. The PDP of claim 5, wherein one of the red discharge cells, one of the green discharge cells, one of the blue discharge cells, and one of the white discharge cells form a pixel.

9. The PDP of claim 5, wherein each of the first discharge electrodes comprises a X electrode and a Y electrode extending substantially parallel to the X electrode.

10. The PDP of claim 5, further comprising a first dielectric layer formed on an inward surface of the first substrate, the first electrodes being disposed between the first substrate and the first dielectric layer.

11. The PDP of claim 10, wherein the first electrodes are disposed between the first substrate and the barrier rib.

12. The PDP of claim 5, further comprising a second dielectric layer formed on an inward surface of the second substrate, the second electrodes being disposed between the second substrate and the second dielectric layer.
